(19) United States
(12) Patent Application Publication
(10) Pub. No.: US 2015/0271172 A1
(43) Pub. Date: Sep. 24, 2015

(54) Secure cloud computing system

(71) Applicant: Christopher Luis Hamlin, San Jose, CA (US)

(72) Inventor: Christopher Luis Hamlin, San Jose, CA (US)

(21) Appl. No.: 13/999,757

(22) Filed: Mar. 18, 2014

(51) Int. Cl. H04L 29/06; H04L 9/32

(52) U.S. Cl. CPC H04L 63/0853; H04L 9/321

(57) ABSTRACT

The present invention provides a method and apparatus for securing electronic systems, including computers, information appliances and communication devices. The invention in question addresses the problem of preventing compromise by severe attacks directed at the protected systems. A severe attack could mean any of the following: low level debugging, use of in-circuit emulators or logic analyzers, removal of silicon dice and inspection including by lapping and micro-photography, and other well-known methods of attack such as distributed denial of service. In order to protect systems and data from such severe attacks, a mechanism is required whose operation is irreparably altered by the attempt to understand its operation through such attacks. Moreover, the mechanism must cease operation instantly upon detection of any intrusion associated with an attack, whether by software or by hardware based means.

### CROSS-REFERENCE TO A RELATED U.S. PATENT APPLICATION & CLAIMS FOR PRIORITY

The Present Continuation-in-Part Patent Application is related to Provisional Patent Application U.S. Ser. No. 61/461,473, now abandoned, which was filed on 18 Jan. 2011; and to Pending Non-Provisional Patent Application U.S. Ser. No. 13/199,050, filed on 16 Aug. 2011. The Applicant hereby claims the benefit of priority for any and all subject matter under Sections 119 and/or 120 of Title 35 of the United States Code of Laws which is commonly disclosed in the Present Application, and in U.S. Ser. No. 61/461,473 and U.S. Ser. No. 13/199,050.

### FEDERALLY SPONSORED RESEARCH OR DEVELOPMENT

None.

### FIELD OF THE INVENTION

The present invention pertains to methods and apparatus for improving the security of communication and computing systems. One embodiment of the present invention specifically addresses the problem of preventing compromise by severe attacks directed at a protected system. The present invention may be used to authenticate and safeguard communications from a client's device to a server in the computing cloud.

The present invention pertains to methods and apparatus for securing electronic systems communicating over wired and wireless connections, and the data being so communicated. The present invention specifically addresses the problem of preventing compromise by severe attacks directed at the protected systems. A severe attack could mean any of the following: low level debugging, use of in-circuit emulators or logic analyzers, removal of silicon die and inspection including by lapping and micro-photography, and other well-known methods of attack such as distributed denial of service.

In order to protect systems and data from such severe attacks, a mechanism is required whose operation is irreparably altered by the attempt to understand its operation through such attacks. Moreover the mechanism must cease operation instantly upon detection of any intrusion associated with an attack, whether by software or by hardware based means.

### BACKGROUND OF THE INVENTION

According to the Gartner Group, total annual spending on computer security systems now exceeds $13.5 billion dollars. Each personal computer and communication device that connects to a network is vulnerable to an attack.

Networked electronics have introduced vulnerabilities into every corner of modern life far more rapidly than society has been able either to appreciate or respond to them. The magnitude of the threat posed by exposure of data to misappropriation, abuse, and loss grows steadily, while both awareness and mitigation lag far behind.

Such technical and commercial measures as have been applied to date fall far short of what is required to correctly and adequately address the problem. Although a number of new and established companies have entered the field recently, there continue to be severe deficits in the effectiveness or appropriateness of the solutions advanced. Consequently the scope of losses and damage is expanding daily, around the world.

In this disclosure the technical nature of the problem is summarized, the functional requirements for a correct and effective set of solutions are spelled out, a patentable technology approach is disclosed, and all of these are incorporated in a business model aimed at fostering their adoption.

Individuals, government organizations, and businesses have acquired billions of electronic devices in the past three decades capable of storing and communicating all kinds of data. Most of these devices are capable of communicating over various kinds of wired or wireless media. By far the most widely used such communications facility is the Internet.

The vast repositories of data and content which society had accumulated in the form of analog storage media began to migrate to networked digital storage forms, and people shifted from being users of paper and pen to users of electronic computers, personal digital assistants, cell phones, digital camcorders, digital televisions, data centers, and the like.

A de facto physical model for the protection of data had arisen over the past couple of hundred years: safety deposit boxes, vaults, shoe boxes in closets, wallets, handbags, file cabinets, armored cars, and so on, all of which presented tangible physical barriers of varying degrees of effectiveness against intruders and thieves.

The torrential flood of data and content from physical (mostly analog) form to electromagnetic traces on digital storage and communications media occurred so rapidly, and brought so many functional and economic benefits, that little or no thought was given at first to whether or how the safeguards which had built up gradually over time to protect the physical form of the data and content could be applied in similar fashion to the vast repositories expanding exponentially on digital mass storage devices which were linked via internetworked communication.

Somewhat ironically, at almost the same time that the brave new world of networked electronics was being created, profound mathematical breakthroughs in the construction of codes for making messages unintelligible to any but their owners or intended recipients were being announced and in some cases applied in practice. But although theoretically these breakthroughs held the promise of continuing to apply analogous protections over what had been physical data as they migrated to the networked, digitally stored world, in fact they found very restricted application, and even then often in implementations suffering critical weaknesses or vulnerabilities.

Thus today almost everything known by society and about individuals is recorded somewhere in electronic form, and to an absolutely stunning degree is open to inspection by anyone with a modicum of technical know-how.

And at the same time the control structures governing the behavior and integrity of the nation's infrastructure—power generation, transportation, environmental monitoring, scientific instrumentation, and so on—was also transferred to the realm of digital storage and communications.

These twin migrations of data and control to digital storage and networks, in the absence of adequate protections governing access to and use of these assets have created risks for society without precedent in human history.

Today the canonical solution that is applied to this problem is two-fold: 1) data are encrypted for communication or storage or both, and 2) access to stored repositories is regulated through passwords controlling systems, accounts and/or files.

At the same time that the deluge of digital data has swelled and the protection methods have lagged, criminal elements with increasing levels of sophistication have become aware that the networked data and electronics upon which society has become wholly dependent offered them the opportunity for enrichment, and that these information assets were extremely poorly guarded.

This has meant that attacks on such protections as do exist have grown in frequency, severity, sophistication, and effectiveness as the potential returns have blossomed. It is clear that criminal elements have learned to invest significantly in developing technologies to assist their attacks.

The recent explosive growth of devices which will now rely on accessing operating systems, application software and data stored “in the cloud” creates an enormous demand for a security system that will protect these types of communications.

The development of such a mechanism would constitute a major technological advance, and would satisfy long felt needs and aspirations in the computer networking and Internet industries.

### SUMMARY OF THE INVENTION

The present invention provides a method and apparatus for securing electronic systems, including computers, information appliances and communication devices.

The invention in question addresses the problem of preventing compromise by severe attacks directed at the protected systems. A severe attack could mean any of the following: low level debugging, use of in-circuit emulators or logic analyzers, removal of silicon dice and inspection including by lapping and micro-photography, and other well-known methods of attack such as distributed denial of service.

In order to protect systems and data from such severe attacks, a mechanism is required whose operation is irreparably altered by the attempt to understand its operation through such attacks. Moreover, the mechanism must cease operation instantly upon detection of any intrusion associated with an attack, whether by software or by hardware based means.

One embodiment of the present invention enables a client using an IPHONE, iPad, Blackberry or other wireless or wired electronic appliance to authenticate communications which require access to the “computing cloud.”

An appreciation of the other aims and objectives of the present invention and a more complete and comprehensive understanding of this invention may be obtained by studying the following description of a preferred embodiment, and by referring to the accompanying drawings.

### A BRIEF DESCRIPTION OF THE DRAWINGS

FIG. 1 shows a person using a mobile electronic device, such as an IPHONE™, to communicate with “the cloud.”

FIG. 2 shows a person placing a call which is routed through the cloud to his bank. The person requests a transfer of funds to a specified recipient.

FIG. 3 portrays a response being dispatched back to the customer, requesting authentication of his request for a transfer of funds.

FIG. 4 depicts the transmission of the authentication to the cloud.

FIG. 5 offers a view of an identity verification from the cloud back to the customer.

FIG. 6 supplies a view of the customer receiving a confirmation that the transfer has been completed, and also shows the receipt of the transfer by the intended recipient.

FIG. 7 is an illustration which shows the basic embodiment of the present invention.

FIG. 8 is an illustration which shows an alternate implementation of the basic embodiment of the present invention.

FIG. 9 is an illustration which shows the basic embodiment of the present invention.

FIG. 10 is an illustration which shows an alternate implementation of the basic embodiment of the present invention.

FIG. 11 is an illustration which shows the basic embodiment of the invention located within an integrated circuit.

FIGS. 12 and 13 present schematic block diagrams of one particular embodiment of the present invention.

FIG. 14 portrays one particular embodiment of a client circuit which is incorporated in the block diagram shown in FIG. 12.

### A DETAILED DESCRIPTION OF PREFERRED & ALTERNATIVE EMBODIMENTS

### Section 1

### Overview of the Invention

The present invention provides methods for securing computing and communications systems. In one embodiment, the present invention comprises new hardware and/or software that may be added to a smart phone, such as an IPHONE™, IPAD™, BLACKBERRY™, personal computer, server or any other suitable wired or wireless device that may be used to send and/or receive a message, data or other form of intelligence.

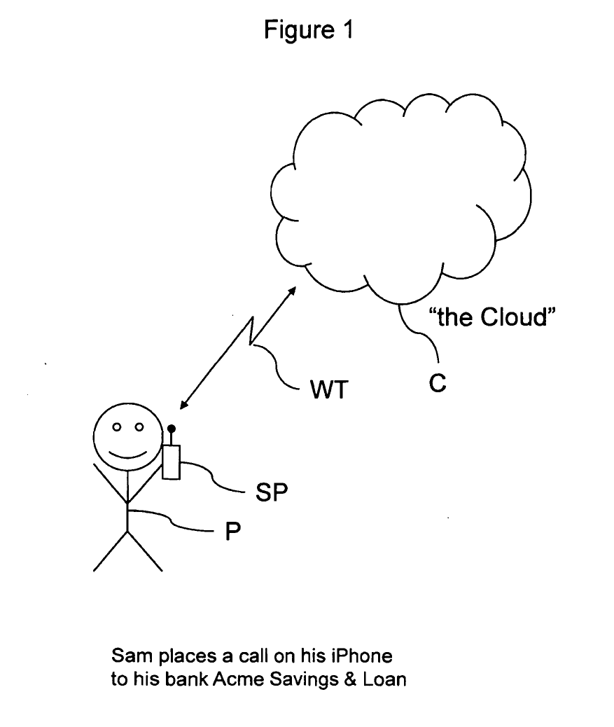

FIG. 1 shows a person P who uses his smart phone SP or some other suitable electronic device to generate a wireless transmission WT. The wireless transmission WT is received by some other remote electronic device that is generically referred to as “the cloud” C. In this particular example, the wireless transmission WT is a telephone call to a bank, the Acme Savings & Loan. The call is routed through some combination of telephone or internet network equipment, which collectively represents the cloud C.

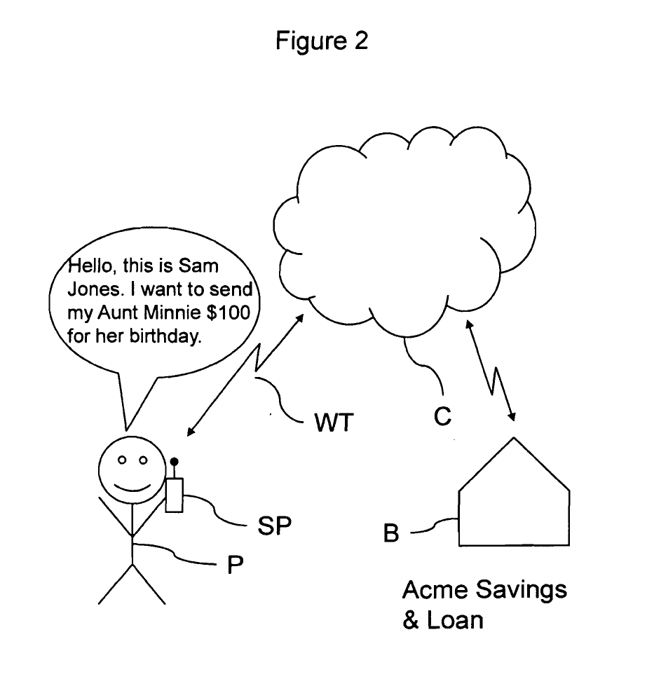

In FIG. 2, the person, Sam Jones, requests his bank B to transfer one hundred dollars from his bank account to his Aunt Minnie AM as a birthday present.

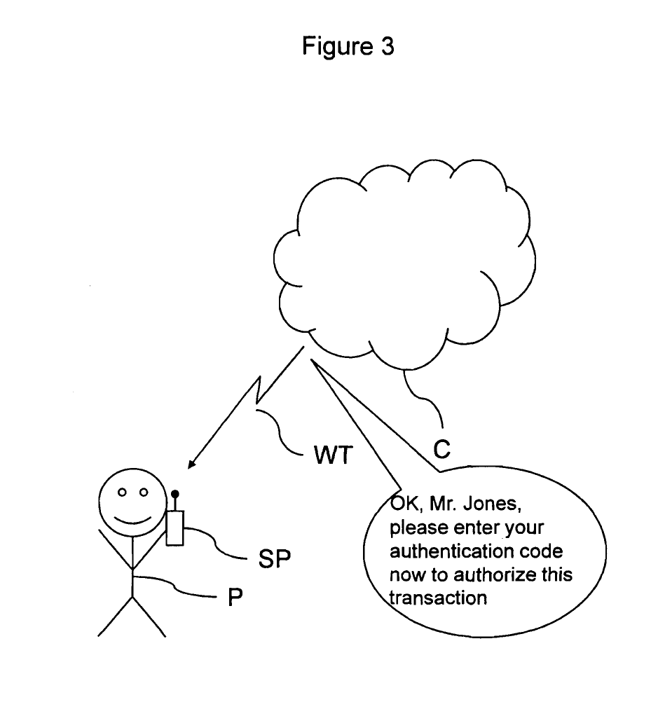

In FIG. 3, some combination of hardware and/or software in the cloud C responds to Sam's call by requesting a verification of his identity that will enable the transaction to proceed.

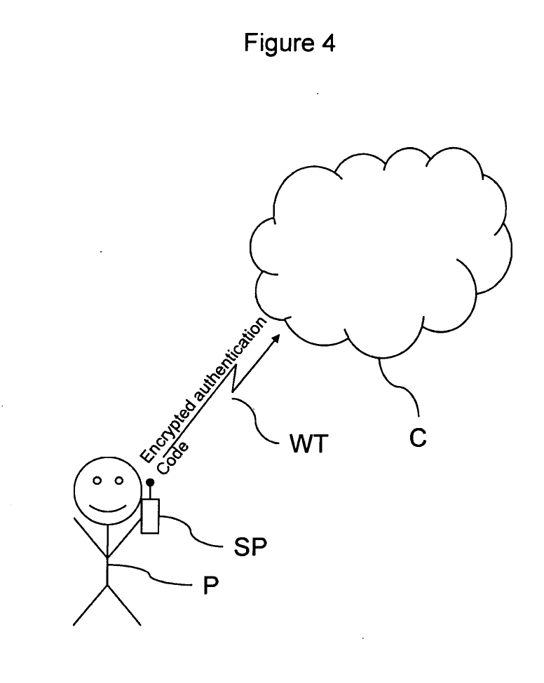

FIG. 4 shows an encrypted authentication code being transmitted back to the cloud C to verify Sam's identity. In one embodiment of the invention, this step is accomplished by hardware which has been added to a conventional smart phone, or by a software application which has been loaded on a conventional smart phone, or by some combination of hardware and software. A specific example for this step is described below in Section 19.

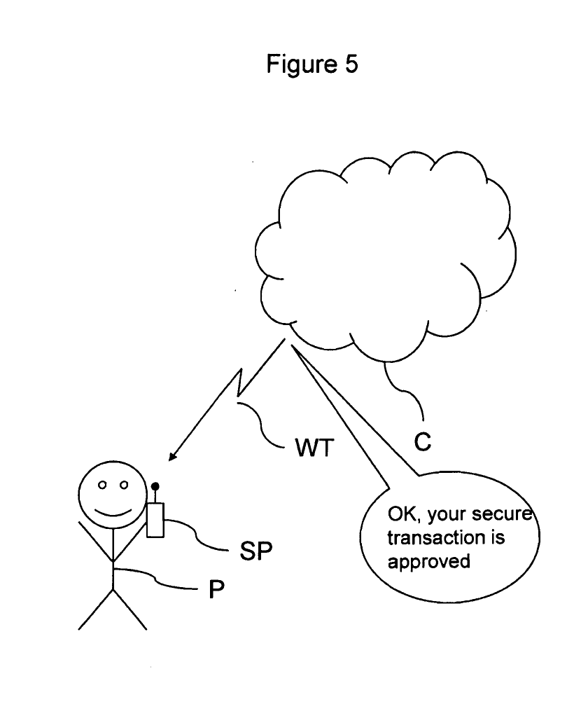

FIG. 5 depicts a message that is transmitted back to Sam, indicating that this transfer of funds has been approved.

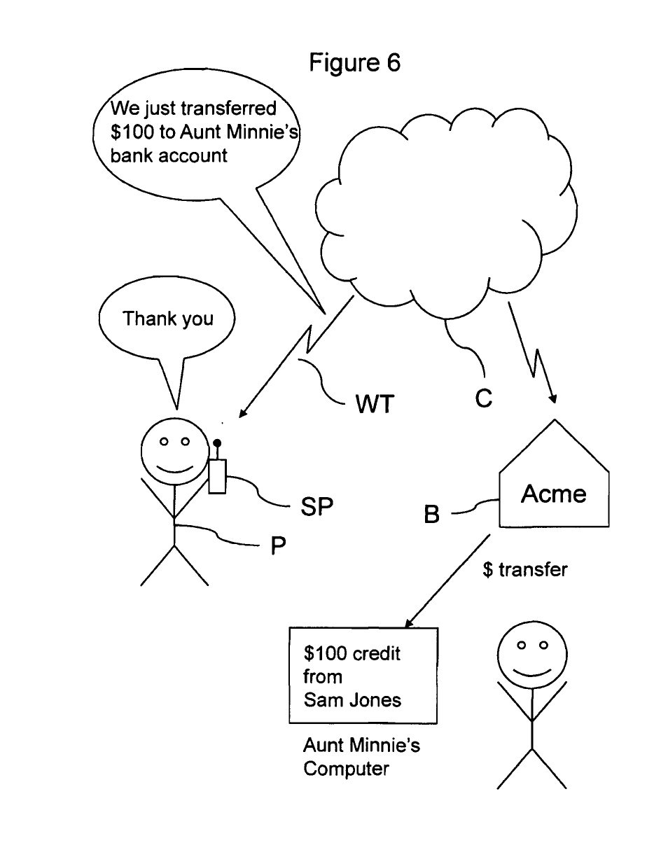

FIG. 6 shows that the transfer of funds to Aunt Minnie has been completed.

### Section 2

### The Problem that Needs a Solution

Sections 2 through 16 describe the scope of the problems addressed by the present invention, and the general approach of the specific embodiments described in Sections 17 through 19.

It is well documented that successful attacks against information systems of all kinds are increasing rapidly (as of 2009). This is true in all sectors, including:

personal computers on the Internet

secure government systems and networks

cell phones

wireless devices

GPS receivers

banking systems and ATMs

medical information systems and electronics

retail credit reporting systems

credit card authorization

online commercial transactions

networked digital media

utility infrastructure including power plants and grid

satellite communications

entertainment systems and assets

social networks

personal digital media

educational records

criminal justice reporting systems

proprietary data repositories

business and financial transactions

tax reporting

network usage histories

census data

search patterns

Clearly society at large is moving toward ever greater dependency on the speed and structural connectedness of the networked world of stored data communications.

### Section 3

### Nature of the Problem

Individuals, government organizations, and businesses have acquired billions of electronic devices in the past three decades capable of storing and communicating all kinds of data. Most of these devices are capable of communicating over various kinds of wired or wireless media. By far the most widely used such communications facility is the Internet.

The vast repositories of data and content which society had accumulated in the form of analog storage media began to migrate to networked digital storage forms, and people shifted from being users of paper and pen to users of electronic computers, personal digital assistants, cell phones, digital camcorders, digital televisions, data centers, and the like.

The deluge of digital data has swelled and the protection methods have lagged, criminal elements with increasing levels of sophistication have become aware that the networked data and electronics upon which society has become wholly dependent offered them the opportunity for enrichment, and that these information assets were extremely poorly guarded.

This has meant that attacks on such protections as do exist have grown in frequency, severity, sophistication, and effectiveness as the potential returns have blossomed. It is clear that criminal elements have learned to invest significantly in developing technologies to assist their attacks.

### Section 4

### Definition of Scope, Means, and Objectives

Two fundamental principles govern the quest for necessary and sufficient means to prevent security breaches. The first is that any methodology must be rejected as inadequate which locks the barn door after the horse is stolen. The second is that any solution must be founded at the deepest level of the information technology at issue: sufficiently strong solutions cannot be built on weak foundations.

A corollary principle is that there is no such thing as a completely, totally secure system. Any system can be defeated given enough time and money. Thus in designing defensive systems a three-fold evaluation must be undertaken (this may be thought of as a three-dimensional model). These dimensions are cost, threat, and risk. Cost refers to the amount which must be spent to implement and maintain a chosen solution. Threat refers to the investment which an attacker is willing to devote to defeating the system. Risk refers to the value of the assets under protection, and the consequences for their owner should a breach occur.

Any proposed solution to the problem of security for networked electronics may be placed in this three-dimensional cost-threat-risk space. The adequacy of the measures can then be evaluated in relation to the magnitude or intensity of expected attacks, and the value of potential losses should a successful attack be endured.

In order to succeed as a general solution to the problems of data and identity security, the proposed technology must meet certain criteria; these are:
1) No secret method (Kerckhoffs' Principle)—the technique must not depend on a structure or internal secret which, once discovered, would compromise the entire technology. At most a single use of a single instance of the technology should be placed in jeopardy through discovery of, say, a key or password. It must be possible for the underlying technology to be well known, without undermining its effectiveness.
2) Low cost—the technology must be deployable in effective implementations whose cost is appropriately matched to the particular cost-threat-risk model in which it participates.
3) Wide scaling range—the technology must be suited to the full range of electronic devices requiring protection, from smart cards and sales tags to massive data center servers and supercomputers.
4) Wide application range—the technology must be equally well suited to digital rights management applications, data communications protection, secure computing environments, command and control applications, and consumer computing, telephony and entertainment.
5) Implementation flexibility—various suitable forms of the technology must be possible encompassing software, firmware, and hardware instantiations, as well as combinations of these, chosen to fit the cost-threat-risk equation appropriately.
6) Limited risk exposure—the architecture must provide for limitation of damage in the event of a successful penetration of the system, by confining exposure to a single processing cycle on a single device utilizing a single medium exposing a single file, for instance, as opposed to exposing a large number of clients, media, and accounts through just one single penetration.

The system disclosed must also be consistent with Kerckhoffs' Principle: A cryptosystem must be secure even if everything about the system, except the key, is public knowledge.

### Section 5

### Anticipated Means of Attack

The invention disclosed in this specification is designed to safeguard implementers against any attack falling within the cost-threat-risk space whatsoever. That is the only posture which is consistent with rejecting a lock-the-barn-door-after-the-horse-is-stolen policy. It is unacceptable that it be possible for a single successful low probability attack to jeopardize high value content.

This imposes a severe burden on the chosen technology. In particular it must be proof against:
1) Deep debugging, in which a target device is placed under the control of a high-capability low level debugging tool;
2) Inspection utilizing an ICE (in-circuit emulator) or other means of examining and controlling the bused signals in the system;
3) Deconstruction of the integrated circuit dice comprising the system, through for example lapping, staining and photomicrographing successive layers of the die;
4) Snooping any communications links into or from the device(s) under attack;
5) Introduction of malware capable of keystroke logging, viral infection, denial of service, trojan horse installation, and so on;
6) Attacks through logically or physically destructive intervention, including for example massive irradiation of target devices, heating or freezing, buffer flooding and overflow, repeated resets, voltage variation, illegal instructions, protocol violations, and so on;
7) It is assumed that the attacker has the ability to inspect and record any and all signals of interest going into and coming from the candidate device.

### Section 6

### Principles of Operation

In order to secure electronic devices against all attacks, such that no loss of data can occur, the proposed solution depends on a fundamental principle:
All protection mechanisms must inherently incorporate interdependent horizontal (structural) and vertical (non-linear) components.

In other words, the necessary and sufficient conditions for validating a legitimate transaction must be fulfilled by necessary interdependent structural and non-linear features, the absence of any of which will invalidate a transaction.

The reason this is essential is that attackers must be assumed capable of extracting any level of detail desired from the purely structural features of the device under attack, using the methods listed above among others. The level of sophistication of the attacker must be assumed to be very high, at least as high as the cost-threat-risk model being adopted would imply.

Thus the proposed solution implements the following heuristic: a non-linear key arises within the die such that the signal properties giving rise to it cannot be observed or inferred externally, either directly or indirectly. The non-linear key's value may be made known to a trusted authority (the definition of ‘trusted authority’ is elaborated below). The trusted authority asserts a value (which may be a single bit) during the pendency of a duration we may call an ‘epoch.’

The device under test for authenticity either recognizes the asserted bit as consistent with its algorithms during the test epoch, or, in the event the bit is suspect (i.e., in error), instantly ceases operation.

The attacker cannot infer the non-linear basis for deriving the key; this is because any attempt to reverse engineer the mechanism generating the key value instantly destroys the basis for generating it, on analogy with the uncertainty principle.

Without knowing the basis, the attacker can only flip a coin. Within a number of epochs which may be made as small as we please, the probability of producing a contradiction to the expected value or values becomes as high as we wish to make it, consistent with our cost-threat-risk model.

Upon failure of the authenticity test, the system architect has many choices. The candidate device may be tentatively reset; it may be assigned a new serial number and restored to operation on probation; its media may be invalidated although the device is given a clean bill of health; or the entire nexus may be taken out of operation. Diagnostic tools may be deployed to assess the nature of the suspected breach attempt, and appropriate countermeasures undertaken.

### Section 7

### Mechanism

The mechanism for producing a suitable non-linear key is next described. The fine details of the mechanism depend upon whether the implementation will generate keys in hardware, in software, in firmware, or in a combination of these modalities.

A non-linear marker is established for the particular instance of the technology, such that its operation and behavior cannot be discerned, either directly while in operation (in other words, under power) or by inference through physical examination of its structure, as by lapping the die.

The non-linear marker becomes the basis for creating a specific bit string which presents an insuperable inverse problem insoluble within a suitable epoch (perhaps the age of the universe, say);

The bit string is presented externally, possibly following suitable encryption. (It might serve to seed the production of an encrypted message, though it needn't). From this point forward the attacker is assumed able to inspect inputs and outputs.

The attacker observes the assertion of bit values by the trusted authority. In order to usurp the role of the trusted authority, and therefore to take over control of the target device, the attacker must be able to predict flawlessly the sequence of key bits corresponding to those arising from the signal generator(s) and ADC(s) internal to the device, whose operation cannot be observed (without stopping them) or inferred (since their behavior would be irreparably altered by any attempt to detect or predict their operation through physical examination).

### Section 8

### One Embodiment of the Invention

The present invention includes a method and apparatus for securing electronic systems communicating over wired and wireless connections, and the data being so communicated.

The invention in question addresses the problem of preventing compromise by severe attacks directed at the protected systems. A severe attack could mean any of the following: low level debugging, use of in-circuit emulators or logic analyzers, removal of silicon dice and inspection including by lapping and micro-photography, and other well-known methods of attack such as distributed denial of service.

In order to protect systems and data from such severe attacks, a mechanism is required whose operation is irreparably altered by the attempt to understand its operation through such attacks. Moreover the mechanism must cease operation instantly upon detection of any intrusion associated with an attack, whether by software or by hardware based means.

In order to fulfill these requirements, a device must offer three properties:
A. Its critical signals and behavior must be unintelligible external to the die;
B. It must present non-linear and spatial components of identity;
C. It must be able to detect intrusion and respond by ceasing operation.

The present invention is designed to provide these features.

### Section 9

### A Description of One Embodiment of the Invention

The present invention depends upon certain semiconductor circuit types which are well known. These include signal generators, amplifiers, and ADCs among others.

The behavior of a set of signal generators may either be regular or irregular. Many well known phenomena give rise to irregularity or instability in the behavior of signal generators, including mismatch between transistors' gain or other parameters.

Under certain well known conditions it is possible to create circuits which will produce consistent behavior whose characteristics of frequency, phase, amplitude, and form exhibit irregularity which cannot be known in advance, as a consequence of variation in the manufacturing process, but which may be sensed or characterized at the time of manufacture. Ordinarily every effort is made to curtail or eliminate such variation.

However the present invention takes advantage of variation by using it to create a unique signal within a semiconductor circuit whose frequency, phase, and amplitude characteristics, while they cannot be predicted in advance, may be known and measured following (perhaps partial) fabrication of the die bearing the circuit elements.

If part way through the manufacturing process these characteristics for a set of, for example, signal generator circuits are measured and stored, then when the fabrication of the die is completed the operation of the circuits producing these signals may be made unknowable to any external observer. In addition, the circuits may be made to depend in well known ways upon the integrity of the three-dimensional integument of the die such that any attempt to penetrate to the locus of the circuits will permanently alter their behavior.

The properties of the circuits giving rise to the unique combinations of frequency, phase, amplitude and form exhibited by each cannot be divined through mechanical or electrical inspection without permanently altering the very structures (which are unanalyzable by static inspection in the first place) in the process.

Thus no attacker can hope to gain knowledge of the properties giving rise to the unique behaviors of the (for example) signal generator circuits without destroying the behaviors sought in the first place.

The signals thus generated and measured during the manufacturing process form Part One of the invention here disclosed.

Part Two comprises a digital mechanism for consistently presenting the output(s) of these circuits to an external environment in which they may be used for purposes of authentication of, for example, an encryption process, a licensed medium or datum, a piece of hardware, or an associated biometric process.

The output of the mechanism of Part Two is assumed to be available to the attacker without excessive difficulty. It must therefore be subject to challenge and response by a trusted authority which knows the internal characteristics of the die in question. In this way the trusted authority may at its discretion issue a challenge and accept the response (or the operation may be inverted) in a manner which the attacker has no way of understanding or replicating without full knowledge of the behavior of the die or dice comprising the system.

In one embodiment, this transformation is accomplished in the following way: the frequency, phase, amplitude(s) and forms of the irregularly varying (for example) circuits of part one, are used to create fluctuations in or modulations of the edges of the control lines governing the latches capturing the coefficients of polynomials entered into linear feedback shift registers. In other words the precise instant at which the output of the ADCs is valid is dictated in one embodiment by the variation imposed upon its several latches' edges by the variable circuits of part one.

Thus although an attacker might hope to gain knowledge of the structure of the process generating the bit streams through inspection of the die internals, the eventual output is a joint function of the set of coefficients introduced into the ADCs on the latch edges induced by the variable circuits (whose operation is unknowable other than to the manufacturer) and possible encryption facility of part one.

By (a) knowledge of the frequencies, phases, amplitudes and forms of the part one circuit(s), and (b) imposition of coefficients on the inputs to the part two ADCs whose output value(s) and timing possibly depend upon variability induced by the part one signals, a trusted authority and only a trusted authority may build up a framework of trust in a large, heterogeneous system, any of whose members may be validated at any point, and any of whose members undergoing attack may instantly be decommissioned.

### Section 10

### Summary of One Embodiment of the Invention

The three requirements enumerated above are met by the invention disclosed here: cessation of operation upon intrusion, convolution of a non-linear with a structural principle of operation, and immunity to external inspection of critical signals.

A device so fabricated using well known methods and techniques may be employed as the foundation for a hierarchy or network of similarly secure devices, each depending upon the other, and supporting management heuristics followed by a governing trusted authority having knowledge of the identifying signal complexes for each member device.

Impostors and mimics can readily be detected and excluded, and compromised members may be decommissioned or reset according to protocol.

### Section 11

### Characterization

Characterization must be the starting point of any systematic approach to the problems of security and privacy in stored data communication systems.

This means that it is possible to state explicitly and precisely the specific conditions and criteria which determine the effectiveness and limitations of any particular solution to a given problem of security or privacy protection.

One such form of characterization is specification of the resources and capabilities of the attacker.

Another is the degree of availability of the system under attack to inspection by the attacker.

A third is the properties of the types of system which are to be defended against attacks.

This insistence on characterization as the starting point stems from the fact that risks and vulnerabilities can only be analyzed and evaluated in such an explicit framework. If the assumptions under which the analysis is carried out are indistinct, vague, or unstated, the analysis will not fully reveal the nature or extent of threats posed by attackers of certain types.

The framework within which to understand characterization may be thought of as a three-dimensional space whose axes are threat, risk and cost. Let us examine each of these in turn.

Threat characterizes the resources and capabilities of the attackers. This is a metric which captures the investment in time, skill and money which the attacker is willing and able to devote to an attempted penetration or other compromise of a system. Loosely speaking, one might think of a gifted high school student with access to a laboratory with a few hundred thousand dollars of equipment, on one end of the scale, and of a large government agency able to deploy hundreds of millions or billions of dollars, together with world-class expertise, on the other.

Risk expresses the value to the owner or anyone else of the assets to be defended against compromise. This entails not just the immediate monetary value, but also the total expense which might be incurred in recovering from a breach exposing the assets to capture by an opponent. The risk also encompasses the seriousness of the compromise: on one hand revelation of innocuous data to a curious but not malevolent hacker, or on the other hand blackmail by a criminal organization in which a business' data are held for ransom.

Cost refers to the level of investment which the owner of the assets to be protected is willing to make to ensure their immunity to compromise. This extends to hardware, software, personnel, training, organizational measures, communications infrastructure, and other expenses necessary to achieving the level of protection deemed essential given the assets under protection.

These axes or dimensions define the space within which any proposed solution must be evaluated. A significant shortcoming of current offerings in the systems security space is their failure to offer rigorous characterization of the position they occupy within the dimensions of cost, threat, and risk. Notice that none of these dimensions is in fact infinite: this means that the analyst of a proposed solution must make choices, sometimes difficult, with respect to the levels of cost, threat, and risk which are at issue in a particular circumstance.

### Section 12

### Spatial Versus Non-Linear Patterns

All security depends upon authentication. All authentication depends upon distinguishing between a genuine entity and a counterfeit entity masquerading as the genuine entity.

In general, authentication applies both to data (in computers, to digital data) and to programs (codes representing computer instructions). The task of the attacker is thus to discover the principles according to which data and programs are authenticated, and to substitute counterfeit versions for his or her own purposes.

In the case of documents, this might entail steganography or concealment of data within an otherwise authentic document (which might be binary, text, audio, video, numeric, or the like).

In the case of programs, it might entail introducing rogue code into the memory or storage regime of the computer in such a way that execution of a legitimate program would silently and undetected cause the execution of the attacker's code.

Once an attacker has succeeded even one time in bringing about the silent and unintended execution of intrusive code, the machine or network in question must be regarded as fatally compromised, because there is no known practical means of deterministically evaluating the extent of penetration or its potential for eventual damage.

Viruses and malware (including rootkits and SMM routines) are the best known and most widespread forms of intrusive program. All of these infection types manifest themselves in the form of patterns which are essentially spatial in nature: that is, they are seen in patterns of bits which one way or another are represented statically with respect to some medium, whether that be memory, magnetic or optical storage, or even a succession of transitions in a communications medium such as copper wire, fiber optics or electromagnetic radiation.

The trait shared by all of these media is the structural constancy of the pattern associated with the intrusion or counterfeiting operation. This is why they are termed “spatial.” A great weakness of all such spatial arrangements of encoded information is that the attacker's decoding analysis is time-based: given sufficient time to work on the problem, any known code can be defeated (although for the best codes known this could amount to several lifetimes of the universe).

### Section 13

### Non-Linearity and Authentication Failure Sensitivity

In order to impose an impossibly short interval on the allowed attack analysis, a non-linear criterion must be added to the spatial one.

Thus codes must be made spatial and non-linear: they must force the attacker to attempt a successful analysis within a specific window. Failing that, the particular instance of an opportunity for attack expires for all time, so that absolutely no incremental, cumulative insight or coding gain is achieved during the pendency of the attempted penetration during the window which might carry over into a subsequent window. Every time the window expires, the attacker is confronted with a new, equally difficult problem to solve, with no residual information derived from previous failed attempts.

Let us call this general approach to protection “watermarking.”

This metaphor conveys the key notion behind spatial and non-linear codes: although in principle the inverse function which lies behind them could be retrodicted from the input data, in practice the interval allotted for solving the problem is insufficient under presently understood methods.

In an actual implementation, a controlling authority with prior knowledge of the correct answer to the coding problem which the system to be authenticated must respond to within the window will validate the system's response, or halt or reset the system.

### Section 14

### The Theoretical Foundation

The approach adopted here implements a simple principle: require the attacker to solve a sufficiently difficult inverse problem within a very small window of time, or lose any possibility of access to the system.

In order to evaluate the degree of difficulty, it is useful to adopt the attacker's point of view, and ask what the vulnerabilities of the watermark system are. (There are many alternative possible instantiations of this principle, varying in effectiveness; for present purposes they are not distinguished).

### Section 15

### Threats and the System Environment

A pristine client communicates with a pristine server over a link which is subject to sampling and inspection by the attacker.

In effect, this is the situation when a secure client and server communicate over the Internet.

From a practical point of view, the user would wish to be enabled safely to incorporate additional data and code (programs) from diverse sources without compromising in any degree the integrity of the client/server system.

This means two things: that the link between the client and the server must be of uncompromised integrity even in the face of inspection and attempted intrusion by the attacker, and that the server is able to acquire and sanitize the requisite assets for distribution to the client.

Given these preliminaries, how does the link work to allow client/server communications in a toxic environment to proceed without fear of compromise or contamination?

The client possesses a non-linear marker known only to the server (and other trusted authorities).

This marker is created at the time of manufacture.

The critical property of this marker (and the reason it is called a non-linear marker) is that it cannot readily be inferred by statically inspecting the die through the usual means (lapping and photomicrography, etc.). Moreover its behavior and operating properties are irreversibly altered through efforts to inspect it in operation; the physical means by which the marker is instantiated are encased within a physical integument which, if penetrated, ceases to function in the manner required to generate the marker in the first place.

The attacker has two options: to record all instances of the security protocol passing between the client and the server over an extended period, hoping to acquire sufficient data to permit an analysis which inverts the function being implemented and thus to emulate it in a successful masquerade, or else to inject content into the stream which passes undetected into the hitherto pristine environment in the form of an infection.

The first option imposes the requirement on the security protocol that it present a sufficiently difficult inverse problem that a) it cannot be solved in an epoch (say, a millisecond), and b) that it cannot gradually be inferred through cumulation of insight over an extended observation period.

The second of these requirements is the more difficult to fulfill.

The spaces traversed by the inverse problem must be so immense and difficult to resolve that the amount of time required to understand them exceeds the useful working lifetime of the apparatus under inspection.

This criterion is in practice not difficult to meet, but it should also be borne in mind that it must at the same time be thoroughly cost effective, so that it may be implemented in low cost consumer and high volume products. In addition, the underlying architecture and algorithms must lend themselves to implementation not only in secure custom silicon, but in programmable and reconfigurable logic of various kinds and in software (it being understood that the instantiations in each of these technologies will occupy very different, though always characterizable, parts of the cost/threat/risk space).

The essence of the security is that the stream passing between the client and the server be hermetically sealed in such a way that any intrusive bit whatsoever is instantly identified and neutralized, and that the authenticity of the client and server be mutually verified both periodically and on demand in a manner whose integrity is ascertainable and which cannot be compromised.

The traditional attack vectors are buffer and stack overflows, flooding, DDoS, interrupt hooking, SMM routines to gain access to ring 0, and higher level corruption through macros or physical disruption such as thermal stressing, electromagnetic abuse, or power cycling to force resets.

### Section 16

### Additional Features

The present invention fulfills the following requirements for secure device authentication:
1. The physical realization in a semiconductor material must protect the identity of the device in the face of photomicrographic or other physical deconstruction of the makeup of the device.
2. The abstract architecture must scale up to and including realizations in software, subject to movement in the cost-threat-risk space as a consequence.
3. The identity architecture must in principle allow for resetting or otherwise restoring the integrity of a unit which has been compromised.
4. The exposure of the hidden of identity of one or a number of instances of the secure identity architecture must not in principle compromise the integrity of the architecture as a whole, or that of other members of the same class of device not so compromised.
5. The cost of the instantiations of the architecture must be low in any of the implementations, whether in hardware or in software.
   Achieving these goals is accomplished in the architecture of the present invention by reliance upon the following principles:
1. Use of a mapping which inherently presents a difficult inverse problem, which is to say one in which forward knowledge of the mapping offers little assistance in backward inference of its source.
2. Use of physical means which are inherently difficult to reconstruct and whose behavior is inherently disrupted in the act of inspecting their composition.
3. Use of formal representation and measure which effectively obscure the source of the identity marker even when their output becomes known.

The general principle followed in this invention is the use of non-linear rather than spatially based manifestations of the required identity marker; in other words a non-linear signature whose physical (i.e. spatial) basis cannot betray the content of the signature in static analysis, and which cannot be inspected in operation without damaging its signature generation properties irreparably.

In the following paragraphs, the general architecture implementing the solution to the foregoing requirements is described.

The invention comprises the following functional blocks:
1. A group of signal generating elements. In the simplest case these might comprise one or more transistor voltage generators. The elements are encased in a three-dimensional structure within the semiconductor device whose identity they encode such that their structure and outputs cannot be observed by physical, electromagnetic, chemical, thermal, or optical means without undermining their capacity to produce the desired identity marker.
2. An encoding apparatus accepting as input the output of the signal generation blocks in the preceding paragraph. This apparatus produces a Hilbert space representation of the output of the signal generation blocks.
3. A further encoding block transforming the output of the Hilbert space encoder by means of any of a number of code space transforms, including possibly but not limited to one or more linear feedback shift registers in cascade.
4. An optional mechanism for accepting adaptive feedback from the trusted authority with which the secure device communicates to allow for dynamic modification of parameters associated with the signal generation block or blocks, the Hilbert space encoder, and the encoding block comprising possibly ADCs and encryption apparatus.

In the software implementation, it is necessary to protect against reverse engineering applied while the target device whose authenticity is secured undergoes attack. For example, the system might experience an effort to use an ICE (in-circuit emulator) and/or logic or bus analyzers to capture the inputs and outputs of the low-level tasks at ring 0 which implement operating system security, thereby exposing the content of the identity marker or the means by which it obscured. To guard against such attacks, the present invention implements the signal generation and encoding functions in SMM space which is protected against interference by mechanisms to be elaborated on subsequently.

Primary attack modes may include ‘man-in-the-middle’.

The attacker seeks two things:
to masquerade undetectably as the authenticated client (or server), and
to introduce undetected forged messages as though legitimate.

The fundamental basis for protection is the difficulty of the inverse problem presented.

The secondary basis for protection is limitation to the scope of penetration.

Scope and difficulty are traded off in the cost-threat-risk space.

The inverse problem is that of inferring the identity marker from observation and analysis of the traffic between client and server.

The scope problem is that of confining a breach to one client and one instance: If the inverse problem is correctly solved, it is solved only for that instance (transaction) on that client.

Deeper insight into a general solution is not gained from one successful attack, and the full cost must be borne for each success. The cost must be high enough that the threat-risk pair do not justify it given the scope.

The N-dimensional content of the identity marker is convolved with the time stamp, the message content, and the ADCs. This constitutes one instantiation or version of the inverse problem.

The signal generators may be exposed through photomicrography, but their signal content will be irrecoverably altered in the process.

Their signal content may be guessed through brute force, but the space will apply to one and only one epoch from an immense number of epochs.

If it is known or suspected that the identity marker for a client has been inferred, it may be changed or removed from service.

The malleability of the inverse problem stems from the trusted authority's ability to alter the values of the identity marker and the polynomial coefficients submitted to the ADCs. This permits secure tests of integrity.

The scheme ultimately hinges on making the probability of guessing or inferring any component of the inverse problem vanishingly small in the context of the threat and risk.

The signal content of the identity marker must offer sufficient complexity that upon convolution with the other components it cannot be retrodicted from the transmitted message, yet will still offer uniqueness guaranteeing correct identification of the authenticated client.

The embodiment of the identity marker must be destroyed by lapping: the signal value(s) must shift sensitively such that no replica could be dependably reconstructed.

The content and contribution of the encoding means and their implication of the time stamp and message authentication (coefficients or the like) must also be shielded within the semiconductor matrix, although their spatial architecture could be revealed by lapping and photomicrography. This again is a function of position in the cost-threat-risk space.

This method is preferred over conventional key exchange because any machine capable of correctly accomplishing a key-based encryption scheme may be replicated through detailed static analysis and reverse engineering of the decryption process: the private key may be made known and the messages formulated or decrypted thereby.

1) Save identity as radar image.—A formalism for representing the identity in Hilbert space is to treat it as a series of chirps as though they emanated from a radar target, assuming the form they would for radar answering certain specific parameters upon encountering a target with the conformation representing the identity marker.
2) Execution timing profiles imposed via custom compilers and vetted through server interactions. In order to support ‘software-only’ instantiations of the algorithm, the non-linear criterion for proving the authenticity of the recovered identity may be derived by allowing a compiler to embed timing markers within the executable, such that certain milestones in execution are encountered with specific timing marks if and only if the code executed has been produced by a valid compiler and has not been tampered with in any way. Thus the spatial (addressing) and non-linear signature of the executable are locked to the identity marker which occupies the Hilbert space, and which can only be recovered successfully if the tamper-free executable encounters each of its milestone markers within the stipulate window.
3) Three-dimensional lock on identity marker, content validity, and link integrity; three-dimensional model: identity plane, data plane, execution plane—execution plane reflects a non-linear surface.
4) Hilbert space representation of trend surface and structural components of identity marker.
5) Sensitive dependency at three levels: random dopant fluctuation (RDF), Hilbert Space reversal challenge, time/lfsr (linear feedback shift register) windows.
6) FPGA: with or without built-in Hilbert protection; Hilbert engine in encapsulated silicon. The generation and comparison of the vector or vectors which are the object of the authentication comparison may be accomplished by specialized and heavily optimized hardware within the semiconductor matrix such that the number of coefficients, the orientation of the vector, and the noise properties associated with its production and measurement are processed in real time with low latency, permitting frequent (e.g. millisecond scale) challenge-response sequences where required under a given cost-threat-risk scenario.
7) Tunable reversibility. The degree of difficulty (degrees of freedom) associated with a particular signal constellation may be made a function of the identity marker specification: number of signal generating elements, polynomial coefficients, noise envelope, and so on. These may be made dynamically adjustable functions of the immediate operating requirements, and may be tuned or adjusted adaptively.
8) Ability to reset dynamically and adaptively.
9) Flicker noise (1/f noise)/RDF. A source of arbitrary variability in the parameters generating the identity marker may arise from the behavior at the time of manufacture of flicker noise or random dopant fluctuation dependent variability which can be used to set the properties of the identity vector or vectors permanently.
10) Manufacturer has no way of knowing signature implications of structures defined. Slight deviations/sensitive dependencies cannot be reliably duplicated/cloned.
11) Wavelet orthonormal basis derived from signature generation. Wavelet analysis forms a convenient tool for generating vectors and characterizing them compactly in terms of wavelets in particular bases (say D4 or the like); Hilbert space could encompass wavelet definition of orthonormal basis.
12) Abstract language in signal vector space—analogous to DTW/HMM recognition with variable acuity and noise injection/filtering; bit string initialization of entity generator by trusted authority; formant/prosody models possible in abstract space for generated entities. The signal value properties of evolution of the signal set may be derived from formant and prosodic features of an arbitrary abstract linguistic construct whose deterministic regularities resemble those of natural language systems (cf. Code Talkers). Analogy: Identity marker is as “speaker (voice)/language/vocabulary”, i.e. signal composition plus prosody in a Hilbert space.
13) A single transistor or a pair exhibiting imperfect matching could act as a sensitive control over the behavior of the signal generator bank and its initialization in phase space or Hilbert spaces; the initialization vector could come from an external source such as the trusted authority. In this way the authenticity may be challenged on demand: a “Q/A” form of challenge/response in which the form of the response is sensitively dependent on the characteristics of the pair (or transistor), which is irreparably disrupted under inspection.
14) Three levels of cumulative strength: arbitrarily fine discrimination of any or all of analog signal generators whose properties may be measured more or less precisely; a choice of ‘language’ made arbitrarily by and conveyed from the trusted authority; and a challenge/response or Q/A session peculiar to an epoch valid only for a finely discriminated ‘voice’ communicating in an arbitrarily selected language, perhaps also peculiar to the epoch.
15) The arbitrary discrimination resolution allows for setting the difficulty of inspecting the apparatus without perturbing its inherent operational qualities to be set to an arbitrary level, thus permitting defeat of the authentication scheme to approach infinite difficulty.
16) Bundles of vectors in Hilbert space comprise total signature, with noise injection obfuscating signal identification.

### Section 17

### A Detailed Description of Preferred & Alternative Embodiments

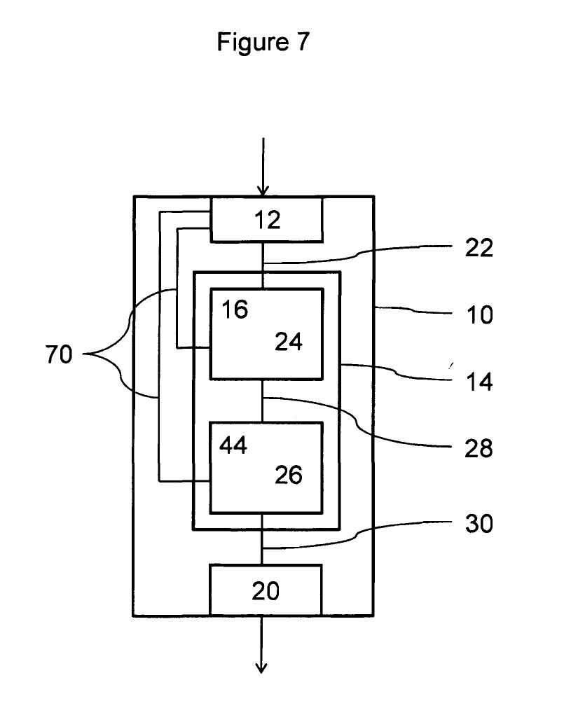

FIG. 7 is an illustration which shows the basic embodiment of the present invention. A multidimensional authentication device 10 contains a signal input mechanism 12, a plurality of signal coding mechanisms 14 including a non-linear coding mechanism 16 and a spatial coding mechanism 44 and a signal output mechanism 20.

The signal input mechanism 12 is connected to the non-linear coding mechanism 16. The non-linear coding mechanism 16 is further connected to the spatial coding mechanism 44. The spatial coding mechanism 44 is further connected to the signal output mechanism 20. The signal input mechanism 12 has control signals 70 that connect to the spatial coding mechanism 44 and the non-linear coding mechanism 16.

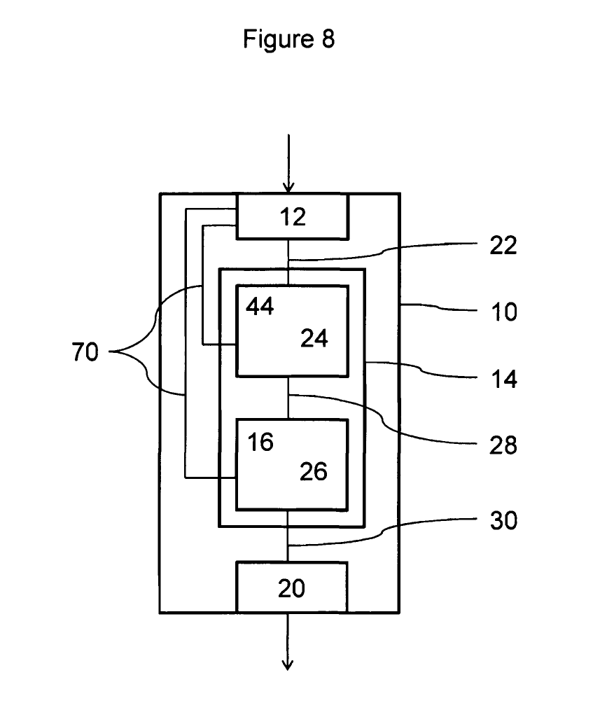

FIG. 8 is an illustration which shows an alternate implementation of the basic embodiment of the present invention. A multidimensional authentication device 10 contains a signal input mechanism 12, a plurality of signal coding mechanisms 14 including a non-linear coding mechanism 16 and a spatial coding mechanism 44 and a signal output mechanism 20. The signal input mechanism 12 is connected to the spatial coding mechanism 44. The spatial coding mechanism 44 is further connected to the non-linear coding mechanism 16. The non-linear coding mechanism 16 is further connected to the signal output mechanism 20. The signal input mechanism 12 has control signals 70 that connect to the spatial coding mechanism 44 and the non-linear coding mechanism 16.

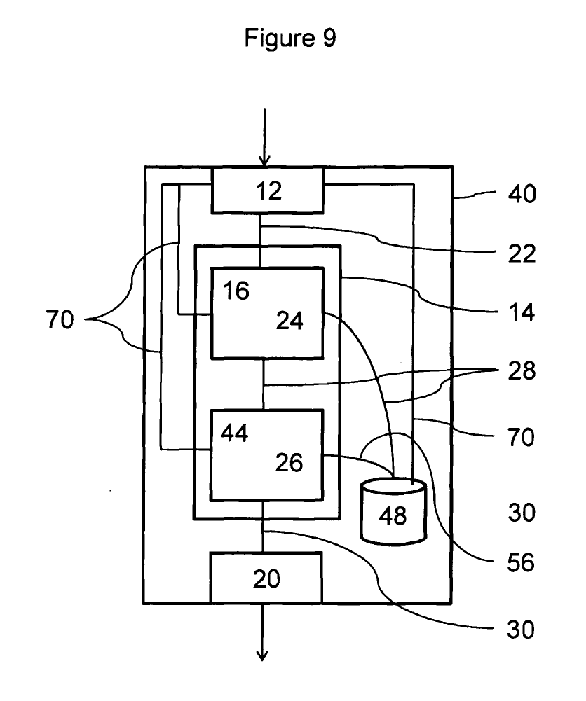

FIG. 9 is an illustration which shows the basic embodiment of the present invention. A multidimensional authentication device with signal storage 40 contains a signal input mechanism 12, a plurality of signal coding mechanisms 14 including a non-linear coding mechanism 16 and a spatial coding mechanism 44, a signal storage mechanism 48, and a signal output mechanism 20. The signal input mechanism 12 is connected to the non-linear coding mechanism 16. The non-linear coding mechanism 16 is further connected to the spatial coding mechanism 44 and the signal storage mechanism 48. The spatial coding mechanism 44 is further connected to the signal storage mechanism 48 and the signal output mechanism 20. The signal input mechanism 12 has control signals 70 that connect to the spatial coding mechanism 44, the non-linear coding mechanism 16 and the signal storage mechanism 48.

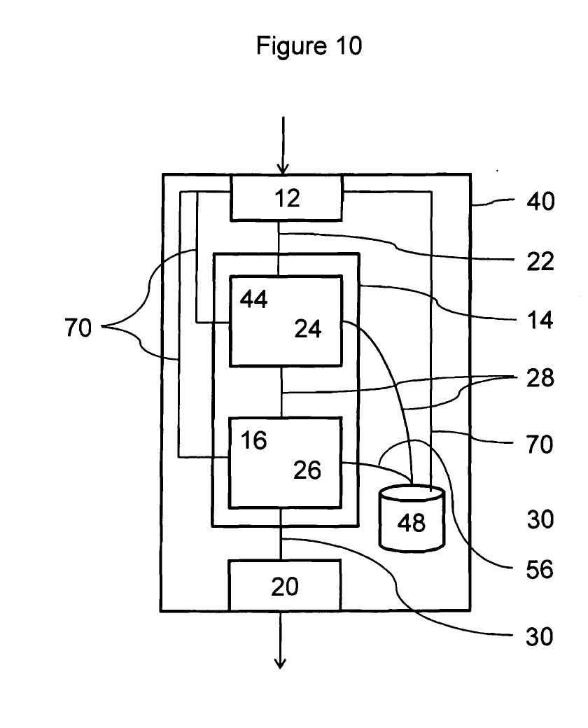

FIG. 10 is an illustration which shows the basic embodiment of the present invention. A multidimensional authentication device with signal storage 40 contains a signal input mechanism 12, a plurality of signal coding mechanisms 14 including a spatial coding mechanism 44 and a non-linear coding mechanism 16, a signal storage mechanism 48, and a signal output mechanism 20. The signal input mechanism 12 is connected to the spatial coding mechanism 44. The spatial coding mechanism 44 is further connected to the non-linear coding mechanism 16 and the signal storage mechanism 48. The non-linear coding mechanism 16 is further connected to the signal storage mechanism 48 and the signal output mechanism 20. The signal input mechanism 12 has control signals 70 that connect to the spatial coding mechanism 44, the non-linear coding mechanism 16 and the signal storage mechanism 48.

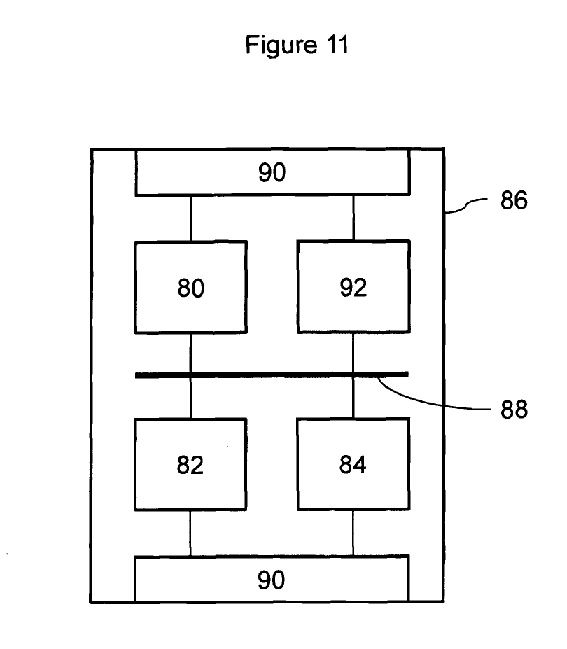

FIG. 11 is an illustration which shows the basic embodiment of the invention located within an integrated circuit. An integrated circuit 86 contains a CPU function 80, a multidimensional authentication function 92, a memory controller function 82, an I/O controller function 84, a memory bus 88 and one or more external signal interfaces 90. The external signal interfaces 90 are connected to the CPU function 80, the multidimensional authentication function 92, the memory controller function 82 and the I/O controller function 84. The CPU function 80, the multidimensional authentication function 92, the memory controller function 82 and the I/O controller 84 function are also connected to each other via the memory bus 88.

### Section 18

### Methods of Operation

FIG. 7 is an illustration which shows the basic embodiment of the present invention. A signal is generated or retrieved by an entity external to the multidimensional authentication device 10. A received signal 22 is sent from the signal input mechanism 12 to the non-linear coding mechanism 16. The non-linear coding mechanism 16 performs a first signal coding 24 on the received signal 22 and sends the first coded signal 28 to the spatial coding mechanism 44. The spatial coding mechanism 44 performs a second signal coding 26 on the first coded signal 28 and sends the second coded signal 30 to the signal output mechanism 20. An entity external to the multidimensional authentication device 10 compares the signal received from the signal output mechanism 20 to a reference signal. If the signals match, then the multidimensional authentication device 10 has not been tampered with. If the signals do not match, then something, either the received signal 22, the multidimensional authentication device 10 or the reference signal has been tampered with.

To control and adjust the operation of the non-linear coding mechanism 16 and the spatial coding mechanism 44, the signal input mechanism 12 can identity control signals and direct them via control signal 70 to the spatial coding mechanism 44 and the non-linear coding mechanism 16.

FIG. 8 is an illustration which shows an alternate implementation of the basic embodiment of the present invention. In this illustration, the order of use of the non-linear coding mechanism 16 and the spatial coding mechanism 44 has been swapped when compared to FIG. 7. A signal is generated or retrieved by an entity external to the multidimensional authentication device 10. A received signal 22 is sent from the signal input mechanism 12 to the spatial coding mechanism 44. The spatial coding mechanism 44 performs a first signal coding 24 on the received signal 22 and sends the first coded signal 28 to the non-linear coding mechanism 16. The non-linear coding mechanism 16 performs a second signal coding 26 on the first coded signal 28 and sends the second coded signal 30 to the signal output mechanism 20. An entity external to the multidimensional authentication device 10 compares the signal received from the signal output mechanism 20 to a reference signal. If the signals match, then the multidimensional authentication device 10 has not been tampered with. If the signals do not match, then something, either the received signal 22, the multidimensional authentication device 10 or the reference signal has been tampered with. To control and adjust the operation of the non-linear coding mechanism 16 and the spatial coding mechanism 44, the signal input mechanism 12 can identity control signals and direct them via control signals 70 to the spatial coding mechanism 44 and the non-linear coding mechanism 16.

FIG. 9 is an illustration which shows the basic embodiment of the present invention. To initialize the multidimensional authentication device with signal storage 40, a signal is generated or retrieved by an entity external to the multidimensional authentication device with signal storage 40 and sent to the signal input mechanism 12. The signal input mechanism 12 separates control information from the received signal and sends a control signal 70 to the spatial coding mechanism 44. The received signal 22 is sent from the signal input mechanism 12 to the non-linear coding mechanism 16. The non-linear coding mechanism 16 performs a first signal coding 24 on the received signal 22 and sends the first coded signal 28 to the spatial coding mechanism 44. The spatial coding mechanism 44 performs a second signal coding 26 on the first coded signal 28 and sends the second coded signal 30 to the signal storage mechanism 48, thus initializing the multidimensional authentication device with signal storage 40.

To authenticate that the multidimensional authentication device with signal storage 40 has not been tampered with, a signal is generated or retrieved by an entity external to the multidimensional authentication device with signal storage 40. A received signal 22 is sent from the signal input mechanism 12 to the non-linear coding mechanism 16. The non-linear coding mechanism 16 performs a first signal coding 24 on the received signal 22 and sends the first coded signal 28 to the spatial coding mechanism 44. The signal storage mechanism 48 sends a stored signal 56 to the spatial coding mechanism 44. The spatial coding mechanism 44 performs a second signal coding 26 on the first coded signal 28 using the stored signal 56 as an additional input and sends the second coded signal 30 to the signal output mechanism 20. An entity external to the multidimensional authentication device with signal storage 40 compares the signal received from the signal output mechanism 20 to a reference signal. If the signals match, then the multidimensional authentication device with signal storage 40 has not been tampered with. If the signals do not match, then something, either the received signal 22, the multidimensional authentication device with signal storage 40 or the reference signal has been tampered with.

To clear initialization data contained within the multidimensional authentication device with signal storage 40, a signal is generated or retrieved by an entity external to the multidimensional authentication device with signal storage 40 and sent to the signal input mechanism 12. The signal input mechanism 12 separates control information from the received signal and sends a control signal 70 to the signal storage mechanism 48. The signal storage mechanism 48 receives the control signal 70 and clears the stored signal, clearing initialization data contained within the multidimensional authentication device with signal storage 40

In an alternate method for clearing initialization data contained within the multidimensional authentication device with signal storage 40, a signal is generated or retrieved by an entity external to the multidimensional authentication device with signal storage 40 and sent to the signal input mechanism 12. The signal input mechanism 12 separates control information from the received signal, sends a control signal 70 to the signal storage mechanism 48 and to the spatial coding mechanism 44. The non-linear coding mechanism 16 performs a first signal coding 24 on the received signal 22 and sends the first coded signal 28 to the spatial coding mechanism 44. The spatial coding mechanism 44 performs a second signal coding 26 on the first coded signal 28 and sends the second coded signal 30 to the signal storage mechanism 48. The signal storage mechanism 48 compares the second coded signal 30 to the signal stored within the signal storage mechanism 48. If the signals match, then the signal stored within the signal storage mechanism 48 is cleared.

FIG. 10 is an illustration which shows an alternate implementation of the basic embodiment of the present invention. In this illustration, the order of use of the non-linear coding mechanism 16 and the spatial coding mechanism 44 has been swapped when compared to FIG. 9.

To initialize the multidimensional authentication device with signal storage 40, a signal is generated or retrieved by an entity external to the multidimensional authentication device with signal storage 40 and sent to the signal input mechanism 12. The signal input mechanism 12 separates control information from the received signal and sends a control signal 70 to the non-linear coding mechanism 16. The received signal 22 is sent from the signal input mechanism 12 to the spatial coding mechanism 44. The spatial coding mechanism 44 performs a first signal coding 24 on the received signal 22 and sends the first coded signal 28 to the non-linear coding mechanism 16. The non-linear coding mechanism 16 performs a second signal coding 26 on the first coded signal 28 and sends the second coded signal 30 to the signal storage mechanism 48, thus initializing the multidimensional authentication device with signal storage 40.

To authenticate that the multidimensional authentication device with signal storage 40 has not been tampered with, a signal is generated or retrieved by an entity external to the multidimensional authentication device with signal storage 40. A received signal 22 is sent from the signal input mechanism 12 to the spatial coding mechanism 44. The spatial coding mechanism 44 performs a first signal coding 24 on the received signal 22 and sends the first coded signal 28 to the non-linear coding mechanism 16. The signal storage mechanism 48 sends a stored signal 56 to the non-linear coding mechanism 16. The non-linear coding mechanism 16 performs a second signal coding 26 on the first coded signal 28 using the stored signal 56 as an additional input and sends the second coded signal 30 to the signal output mechanism 20. An entity external to the multidimensional authentication device with signal storage 40 compares the signal received from the signal output mechanism 20 to a reference signal. If the signals match, then the multidimensional authentication device with signal storage 40 has not been tampered with. If the signals do not match, then something, either the received signal 22, the multidimensional authentication device with signal storage 40 or the reference signal has been tampered with.

To clear initialization data contained within the multidimensional authentication device with signal storage 40, a signal is generated or retrieved by an entity external to the multidimensional authentication device with signal storage 40 and sent to the signal input mechanism 12. The signal input mechanism 12 separates control information from the received signal and sends a control signal 70 to the signal storage mechanism 48. The signal storage mechanism 48 receives the control signal 70 and clears the stored signal, clearing initialization data contained within the multidimensional authentication device with signal storage 40.

In an alternate method for clearing initialization data contained within the multidimensional authentication device with signal storage 40, a signal is generated or retrieved by an entity external to the multidimensional authentication device with signal storage 40 and sent to the signal input mechanism 12. The signal input mechanism 12 separates control information from the received signal, sends a control signal 70 to the signal storage mechanism 48 and to the non-linear coding mechanism 44. The spatial coding mechanism 44 performs a first signal coding 24 on the received signal 22 and sends the first coded signal 28 to the non-linear coding mechanism 16. The non-linear coding mechanism 16 performs a second signal coding 26 on the first coded signal 28 and sends the second coded signal 30 to the signal storage mechanism 48. The signal storage mechanism 48 compares the second coded signal 30 to the signal stored within the signal storage mechanism 48. If the signals match, then the signal stored within the signal storage mechanism 48 is cleared.

In order to protect systems and data from such severe attacks, a mechanism is required whose operation is irreparably altered by the attempt to understand its operation through such attacks. Moreover the mechanism must cease operation instantly upon detection of any intrusion associated with an attack, whether by software or by hardware based means.

A severe attack could mean any of the following: low level debugging, use of in-circuit emulators or logic analyzers, removal of silicon die and inspection including by lapping and micro-photography, and other well-known methods of attack such as distributed denial of service.

### Section 19

### One Embodiment of a Secure Cloud Computing System

Section 19 describes a particular embodiment of the invention which implements the generalized verification and authentication process illustrated in FIGS. 1-6.

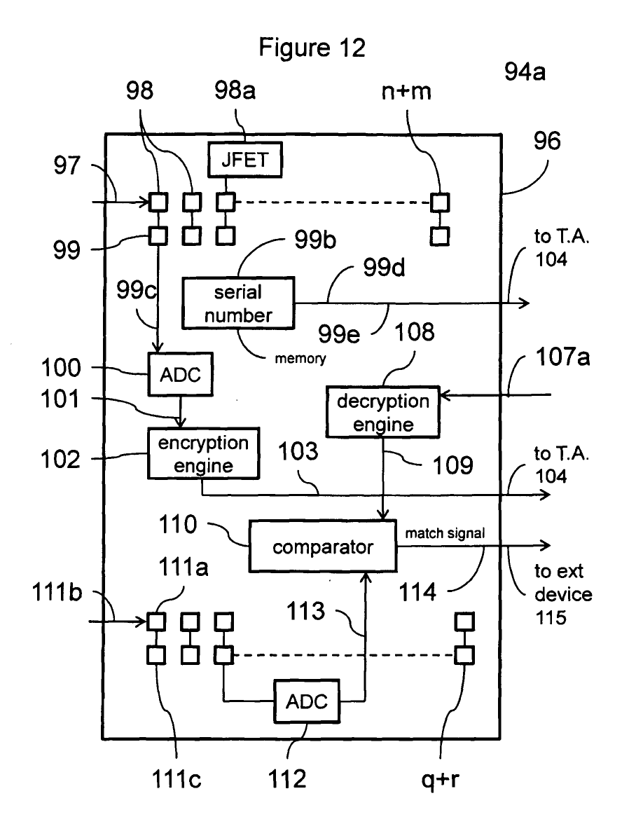

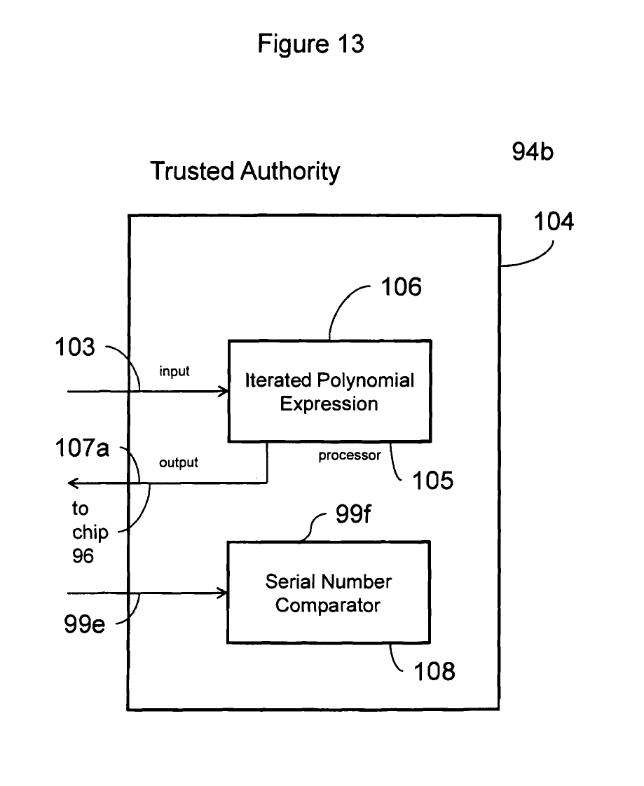

FIGS. 12 and 13 provide schematic block diagrams which depict one particular embodiment 94a & 94b of the invention. In one embodiment of the invention, a chip or a portion of a chip provides a “cell” 96 which is authenticated by the method and/or apparatus of the present invention. In one embodiment, the cell 96 includes one or more query client circuits 98. A query client circuit 98 may constitute any suitable element of electronic hardware. Examples of a client circuit include a resistor, a capacitor, an inductor, a diode, a transistor, a memristor or some combination of these or other suitable component. Any electronic mechanism that produces an electronic output based on an electronic input may be used as a query client circuit 98.

As shown in FIG. 12, each query client circuit 98 in this specific embodiment produces an analog output or value 99c, also noted as value n through value n+m. These output values are produced by an input 97 to each query client circuit 98. The serial number is not encrypted. In this embodiment, the input 97 to each query client circuit 98 may be characterized by a steady state voltage or current.

For any given input 97, the output value of a query client circuit 98 is determined by a specific, known and deliberate manufacturing process. The manufacturing process is configured so that each query client circuit 98 produces an output 99c which is represented by a preselected polynomial expression. In one particular embodiment, the manufacturing process includes the steps of generating an output from a suitable physical electronic device which produces an output that is determined by a carefully pre-selected laser trimming step in which the electronic device is altered by a laser.

Each term in each polynomial expression has a coefficient. For example, in one particular embodiment, the polynomial expression comprises two equations:

x=0.7+0.1x+0.5x²−0.4x³−0.6x⁴−1.1x⁵+0.8x⁴y−1.0x³−0.9x³y²−0.6x²y+0.9x²y²+0.3x²y³−0.7xy+0.8xy²−1.0xy³+0.6xy⁴+0.5y−1.1y²+0.9y³−0.6y⁴+0.1y⁵ Equation 1

y=−0.5−0.2x−1.1x²−0.2x²−0.2x³−0.1x⁴−0.1x⁵+0.5x⁴y−1.2x³y+0.7x³y²+0.5x²y+0.9x²y²−0.9x²y³+0.3xy+0.6xy²−0.2xy³−0.2xy⁴−0.2y−0.8y³+y⁴+0.1y⁵ Equation 2

In one embodiment of the invention, the manufacturing process includes the incorporation of a junction field effect transistor (JFET) 98a.

These output values 99c are fed to an analog-to-digital converter 100, which, in turn, produces a set of digital outputs 101. These digital outputs 101 are conveyed to an encryption engine 102. Any encryption method, including AES, that is available may be used to encrypt the digital outputs from the analog to digital converter 100. The encrypted digital signal 103 is conveyed to a trusted authority 104.

In this embodiment, a single serial number 99b is stored in a memory 99d, and is conveyed unencrypted to the trusted authority 104 as output 99e.

In one particular embodiment, the trusted authority 104 is a remote server which is connected to the cell 96 by some form of wired or wireless network. In other embodiments, the trusted authority 104 may be constituted in any suitable electronic device, including, but not limited to, a personal computer, a smart phone, tablet computer or other information appliance.

The polynomial expression is stored in the trusted authority 104.

Once the encrypted digital signal 103 transmitted from the encryption engine 102 arrives at the trusted authority 104, and is fed to a processor 105. The processor 105 stores and then iterates one or more polynomial expressions 106, as shown in FIG. 13. The product 107a of this iteration is encrypted, and is then sent back from the processor 105 to the chip 96, where it is decrypted by a decryption engine 108. The output 109 of the decryption engine 108 is fed to a comparator 110, which generates a sequence of values, shown in FIG. 12 as value q through value q+r.

A set of response client circuits 111a are shown below the comparator 110 in FIG. 12. In one embodiment of the invention, the query and response client circuits (98 &111a) are identical. In other embodiments, the query and response client circuits are different. Each response client circuit 111a receives an input 111b. In one embodiment, input 111b is characterized by an analog voltage. Each client circuit 111b produces an output 111c. The outputs 111c are fed to an analog-to-digital converter 112, which generates a digital output 113. This digital output 113 is conveyed to the comparator 110.

For the transaction to be successfully authenticated, the input 103 to the trusted authority 104, which is the same as the output 103 of encryption engine 102, must exactly match the result of the iterated polynomial expression 106 received back from the trusted authority 104 as output 107a.

A minute change in the input 103 to the trusted authority 104 will produce a correspondingly massive change in the output 107a of the processor 105 in the trusted authority 104, which would defeat the authentication process.

If the output 103 of the encryption engine 102 dispatched to the trusted authority 104 does not match the value 107a produced by the iteration of the polynomial expression 106 in the trusted authority 104, the authentication fails. If the authentication proceeds, then the comparator 110 issues a match signal 114. In this embodiment, the match signal 114 is conveyed over a wired, wireless or other suitable connection to some external device 115, such as another local or remote computer or server. In this Specification, and in the Claims that follow, the term “authentication” encompasses the approval, verification or other enablement of a request for access, a transaction, an order, a permission, an agreement or consent to some other action initiated by a client.

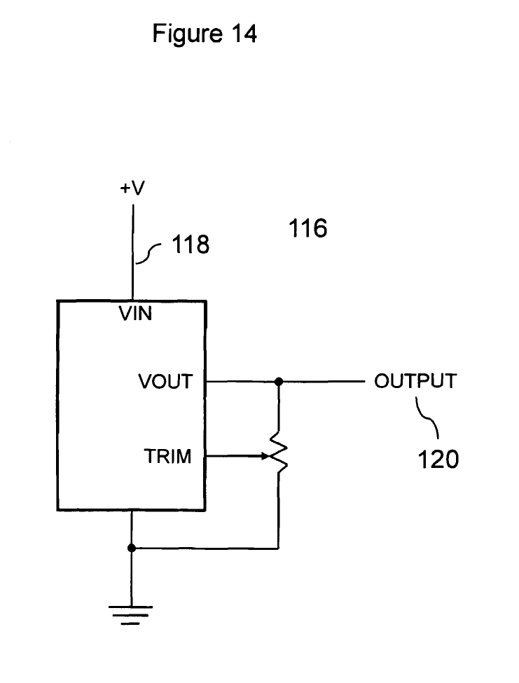

FIG. 14 supplies a schematic diagram of a circuit 116 having an input 118 and an output 120 that may be used as a query or response client circuit 98 or 111a in one specific embodiment of the invention. Any suitable electronic device or discrete portion of a physical substance which is capable of producing an output based on an input may be used to implement the invention.

### CONCLUSION

Although the present invention has been described in detail with reference to one or more preferred embodiments, persons possessing ordinary skill in the art to which this invention pertains will appreciate that various modifications and enhancements may be made without departing from the spirit and scope of the claims that follow. The various alternatives for providing an efficient means for concealing a network connected device that have been disclosed above are intended to educate the reader about preferred embodiments of the invention, and are not intended to constrain the limits of the invention or the scope of Claims. The List of Reference Characters which follows is intended to provide the reader with a convenient means of identifying elements of the invention in the Specification and Drawings. This list is not intended to delineate or narrow the scope of the Claims.

### LIST OF REFERENCE CHARACTERS

10 One embodiment of a Secure Cloud Computing System
12 Signal input mechanism
14 Plurality of coding mechanisms
16 Non-linear coding mechanism
20 Signal output mechanism
22 Signal
24 First signal coding
26 Second signal coding
28 First coded signal
30 Second coded signal
40 Multi-dimensional authentication device with signal storage
44 Spatial coding mechanism
48 Signal storage mechanism
56 Stored signal
70 Control signal
80 CPU
82 Memory Controller
84 I/O Controller
86 Integrated Circuit
88 Memory Bus
90 External Signal Interface
92 Multi-dimensional authentication function
94a & b Cell or Chip
97 Input to client circuit
98 Query client circuits
98a JFET
99b Serial number
99c Outputs from client circuits
99d Memory for storing serial number
99e Output to trusted authority
99f Serial number comparator
100 Analog-to-digital converter
101 Output of a-to-d converter
102 Encryption engine
103 Output of encryption engine
104 Trusted authority
105 Processor in trusted authority
106 Polynomial expressions iterated in processor
107a Output from processor
108 Decryption engine
109 Output from decryption engine
110 Comparator
111a Response client circuit
111b Input to response client circuit
111c Output from response client circuit
112 Analog-to-digital converter
113 Output from a-to-d converter to comparator
114 Match signal
115 External device receiving match signal (not shown)
116 Generic example of query or response client circuit
118 Input
120 Output

What is claimed is:

1. An apparatus comprising:
a multidimensional authentication device (10) containing a signal input mechanism (12), a plurality of signal coding mechanisms (14) including a non-linear coding mechanism (16) and a spatial coding mechanism (44) and a signal output mechanism (20);
said multidimensional authentication device (10) receives a signal (22) via the signal input mechanism (12);
said multidimensional authentication device (10) performs a first signal coding (24) using one of the plurality of said signal coding mechanisms (14) on said received signal (22);
said multidimensional authentication device (10) performs a second signal coding (26) using one of the plurality of said signal coding mechanisms (14) not used on said first coded signal (28); and
said multidimensional authentication device (10) outputs the second coded signal (30) via the signal output mechanism (20);

2. An apparatus comprising:
a signal input mechanism (12);
a plurality of signal coding mechanisms (14) including a non-linear coding mechanism (16) and a spatial coding mechanism (44); and
a signal output mechanism (20).

3. An apparatus comprising:
a multidimensional authentication device (10) with signal storage (40) containing a signal input mechanism (12), a plurality of signal coding mechanisms (14) including a non-linear coding mechanism (16) and a spatial coding mechanism, a signal storage mechanism (48) and a signal output mechanism (20);
said multidimensional authentication device with signal storage (40) receives a signal (22) via the signal input mechanism (12);
said multidimensional authentication device with signal storage (40) performs a first signal coding (24) using one of the plurality of said signal coding mechanisms (14) on said received signal (22);
said multidimensional authentication device with signal storage (40) obtains a stored signal (56) from said signal storage mechanism (48);
said multidimensional authentication device with signal storage (40) performs a second signal coding (26) using one of the plurality of said signal coding mechanisms (14) not used on said first coded signal (28) and on said stored signal (56);
said multidimensional authentication device with signal storage (40) outputs the second coded signal (30) via the signal output mechanism (20).

4. An apparatus comprising:
a signal input mechanism (12);
a plurality of signal coding mechanisms (14) including a non-linear coding mechanism (16) and a spatial coding mechanism (44);
a signal storage mechanism (48); and
a signal output mechanism (20).

5. An apparatus comprising:
a multidimensional authentication device with signal storage (40) containing a signal input mechanism (12), a plurality of signal coding mechanisms (14) including a non-linear coding mechanism (16) and a spatial coding mechanism (44), a signal storage mechanism (48) and a signal output mechanism (20);
said multidimensional authentication device with signal storage (40) receives a signal (22) via the signal input mechanism (12);
said signal input mechanism (12) sends a control signal (70) to the plurality of signal coding mechanisms (14);
said multidimensional authentication device with signal storage (40) performs a first signal coding (24) using one of the plurality of said signal coding mechanisms (14) on said received signal (22);
said multidimensional authentication device with signal storage (40) performs a second signal coding (26) using one of the plurality of said signal coding mechanisms (14) not used on said first coded signal (28); and
said multidimensional authentication device with signal storage (40) stores second coded signal (30) in signal storage mechanism (48).

6. An apparatus comprising:
a multidimensional authentication device with signal storage (40) containing a signal input mechanism (12), a plurality of signal coding mechanisms (14) including a non-linear coding mechanism (16) and a spatial coding mechanism (44), a signal storage mechanism (48) and a signal output mechanism (20);
said multidimensional authentication device with signal storage (40) receives a signal (22) via the signal input mechanism (12);
said signal input mechanism (12) sends a control signal (70) to the signal storage mechanism (48); and
said signal storage mechanism (48) clears a stored signal (56).

7. A method comprising the steps of:
providing a physical structure;
said physical structure being characterized by a non-linear signature;
determining said non-linear signature of said physical structure; and
using said non-linear signature to verify the identity of a source of data.

8. A method as recited in claim 7, in which said physical structure is formed from a semiconductor material.

9. A method as recited in claim 7, in which said physical structure is an oscillator.

10. A method as recited in claim 7, in which said physical structure is an amplifier.

11. A method as recited in claim 7, in which said physical structure is a linear feedback shift register.

12. A method as recited in claim 7, in which said physical structure includes a conductor.

13. A method as recited in claim 7, in which said physical structure includes a resistor.

14. A method as recited in claim 7, in which said physical structure includes a capacitor.

15. A method as recited in claim 7, in which said physical structure includes an inductor.

16. A method as recited in claim 7, in which said physical structure includes an opto-electronic material.

17. A method as recited in claim 7, in which said physical structure is a solid.

18. A method as recited in claim 7, in which said physical structure is a liquid

19. A method as recited in claim 7, in which said physical structure is a gas.

20. A method as recited in claim 7, in which said physical structure is a solid.

21. A method as recited in claim 7, in which said non-linear signature includes a frequency output that is generated in response to an input signal.

22. A method as recited in claim 7, in which said non-linear signature includes an output that is generated in response to an input signal.

23. A method as recited in claim 7, in which said input signal is an electronic signal.

24. A method as recited in claim 7, in which said input signal is an acoustic signal.

25. A method as recited in claim 7, in which said input signal is a mechanical input.

26. A method as recited in claim 7, in which said physical structure includes inorganic material.

27. A method as recited in claim 7, in which said physical structure includes an organic material.

28. A method as recited in claim 7, in which said physical structure includes biological material.

29. A method as recited in claim 7, further comprising the step of:
providing a signal generator to produce an input signal.

30. A method as recited in claim 29, in which said signal generator is an oscillator.

31. A method as recited in claim 29, further comprising the step of:
providing an encoding circuit; said encoding circuit for accepting as input the output of said signal generator.

32. A method as recited in claim 31, in which said encoding circuit produces a Hilbert space representation of the output of said signal generator.

33. A method as recited in claim 31, further comprising the step of:
providing an encoding block for transforming the output of said encoding circuit.

34. A method as recited in claim 33, in which said an encoding block transform the output of said encoding circuit using a code space transform.

35. A method as recited in claim 34, in which said code space transform includes a linear feedback shift registers in cascade.

36. A method comprising the steps of:
providing a software program;
said software program being characterized by a non-linear signature;
determining said non-linear signature of said software program; and
using said non-linear signature to verify the identity of a source of data.

37. A method comprising the steps of:
providing an algorithm;
said algorithm being characterized by a non-linear signature;
determining said non-linear signature of said algorithm; and
using said non-linear signature to verify the identity of a source of data.

38. A method for authenticating a communication comprising the steps of:
providing a query client circuit (98) for producing an analog value (99);
supplying an input (97) to said query client circuit (98);
said analog value (99) being determined by a manufacturing method of said query client circuit (98);
said manufacturing method being based upon a preselected polynomial expression (106) for said query client circuit (98);
said polynomial expression (106) including a term having a coefficient;
providing a trusted authority (104);
said polynomial expression (106) corresponding to said query client circuit (98) being stored in said trusted authority (104);
converting said analog value (99c) to a digital sequence (101) using an analog-to-digital converter (100);
encrypting said digital sequence (101) using an encryption engine (102) to produce an encrypted output (103);
conveying said encrypted output (103) to said trusted authority (104);
conveying an unencrypted serial number (99b) to said trusted authority (104);
storing said encrypted output (103) in a processor (105) inside said trusted authority (104);
iterating said polynomial expression (106) using said processor (105) to produce an output (107a);
sending said output (107a) back to said decryption engine (108) in said chip (96) to produce an output (109);
feeding said output (109) to a comparator (110);
providing a response client circuit (111a); said response client circuit (111a) receiving a second input (111b) and producing an output (111c);
using a comparator (110) to compare said output (109) of said decryption engine (108) to said output (113) of said analog-to-digital converter (112); and
sending an encrypted match signal (114) from said comparator (110) to said trusted authority (104) if said output (109) exactly matches said analog value (111c) from said response client circuit (111a).

39. A method as recited in claim 38, comprising the additional steps of:
storing a reported unencrypted serial number (99b) in said trusted authority (104);
looking up a predicted unencrypted serial number (115); said predicted unencrypted serial number (115) being stored in a database in said trusted authority (104) at the time the trusted authority (104) is manufactured;
said predicted unencrypted serial number corresponding to said output (107a) from said processor (105) in said trusted authority (104);
comparing said reported and said predicted serial numbers (99b & 115);
activating a match signal (116) if both serial numbers are exactly the same.

40. A method as recited in claim 38, in which:
said trusted authority is a server.

41. A method as recited in claim 38, in which:
said trusted authority is an electronic device.

42. A method as recited in claim 38, in which:
said client circuit is embodied in a chip.

43. A method as recited in claim 38, in which:
said client circuit is embodied in software.

44. A method as recited in claim 38, in which:
said client circuit is a resistor.

45. A method as recited in claim 38, in which:
said client circuit is a capacitor.

46. A method as recited in claim 38, in which:
said client circuit is an inductor.

47. A method as recited in claim 38, in which:
said client circuit is a diode.

48. A method as recited in claim 38, in which:
said client circuit is a transistor.

49. A method as recited in claim 38, in which:
said client circuit is a memristor.

50. A method as recited in claim 38, in which:
said input to said client circuit is a steady state voltage.

51. A method as recited in claim 38, in which:
said input to said client circuit is a steady state current.

52. A method as recited in claim 38, in which:
said manufacturing method includes the incorporation of a junction field effect transistor (JFET) in said client circuit.

53. A method as recited in claim 38, in which:
said output (103) of said encryption engine is conveyed to said trusted authority over a wireless network.

54. A method as recited in claim 38, in which:
said output (103) of said encryption engine is conveyed to said trusted authority over a wired network.

55. A method as recited in claim 38, in which:
said second input (111b) is characterized by an input voltage.

56. A method as recited in claim 38, in which:
said response client circuit (111a) produces an analog output (111c).
